(19) United States
(12) Patent Application Publication
(10) Pub. No.: US 2019/0054603 A1
(43) Pub. Date: Feb. 21, 2019

(54) REMOVAL AND INSTALLATION TOOL AND TOOL SET

(71) Applicant: COSDA MANUFACTURING COMPANY, Taichung City (TW)

(72) Inventor: Lai-Cheng LIU, Taichung City (TW)

(21) Appl. No.: 15/679,846

(22) Filed: Aug. 17, 2017

(51) Int. Cl. B25B 27/06

(52) U.S. Cl. CPC B25B 27/062

(57) ABSTRACT

A removal and installation tool for an insert of an axial bore of a device is provided, including: a press member, including a plurality of first engagement structures of at least two different dimensions; an abutting member; a first tubular member, having a first engagement end and a second engagement end which are configured for selective engagement with different two of the plurality of first engagement structures respectively, disengageably abutted against one of the plurality of first engagement structures and being configured for abutment against the insert; a second tubular member, disengageably abutted against the abutting member and being configured for abutment against the device. A tool set is further provided, including a plurality of first tubular members and a plurality of second tubular members.

### BACKGROUND OF THE INVENTION

### Field of the Invention

The present invention relates to a removal and installation tool, more particularly, to a removal and installation tool and a tool set for an insert of an axial bore of a device.

### Description of the Prior Art

In order to correspond to bearings having different dimensions, a modified tool is provided as disclosed in U.S. Pat. No. 1,972,455 and EP 1837127. These two patents disclose a member having a stepped construction for different bearings to sleeve therearound.

U.S. Pat. No. 4,050,136 discloses yet another modified tool including a member having a stepped construction. The member is advantageous in that it is expandable and includes several expandable segments, so as to further correspond to a variety of bearings with different dimensions.

Although U.S. Pat. No. 1,972,455, EP 1837127 and U.S. Pat. No. 4,050,136 provide a stepped design to correspond to bearings of several sizes, the stepped structure thereof inevitably increases the length and volume of the member.

The present invention is, therefore, arisen to obviate or at least mitigate the above mentioned disadvantages.

### SUMMARY OF THE INVENTION

The main object of the present invention is to provide a removal and installation tool and tool set for an insert of an axial bore of a device, which is compatible with various inserts of different sizes.

To achieve the above and other objects, a removal and installation tool for an insert of an axial bore of a device is provided, including: a press member, including a plurality of first engagement structures of at least two different dimensions; an abutting member; a first tubular member, having a first engagement end and a second engagement end which are configured for selective engagement with different two of the plurality of first engagement structures respectively, disengageably abutted against one of the plurality of first engagement structures and being configured for abutment against the insert; a second tubular member, disengageably abutted against the abutting member and being configured for abutment against the device.

To achieve the above and other objects, a removal and installation tool set is provided, including: a plurality of aforementioned first tubular members and a plurality of aforementioned second tubular members.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a perspective view according to a preferred embodiment of the present invention;

FIG. 2A is a drawing showing pairing of tubular members and press/abutting members according to a preferred embodiment of the present invention;

FIG. 2B is another drawing showing pairing of tubular members and press/abutting members according to a preferred embodiment of the present invention;

FIGS. 3-6 are cross-sectional drawings showing four types of parings according to the present invention;

FIG. 7 is an exploded view according to a preferred embodiment of the present invention;

FIG. 8 is a drawing showing a removal and installation tool in use according to a preferred embodiment of the present invention; and

FIG. 9 is another drawing showing a removal and installation tool in use according to a preferred embodiment of the present invention.

### DETAILED DESCRIPTION OF THE PREFERRED EMBODIMENTS

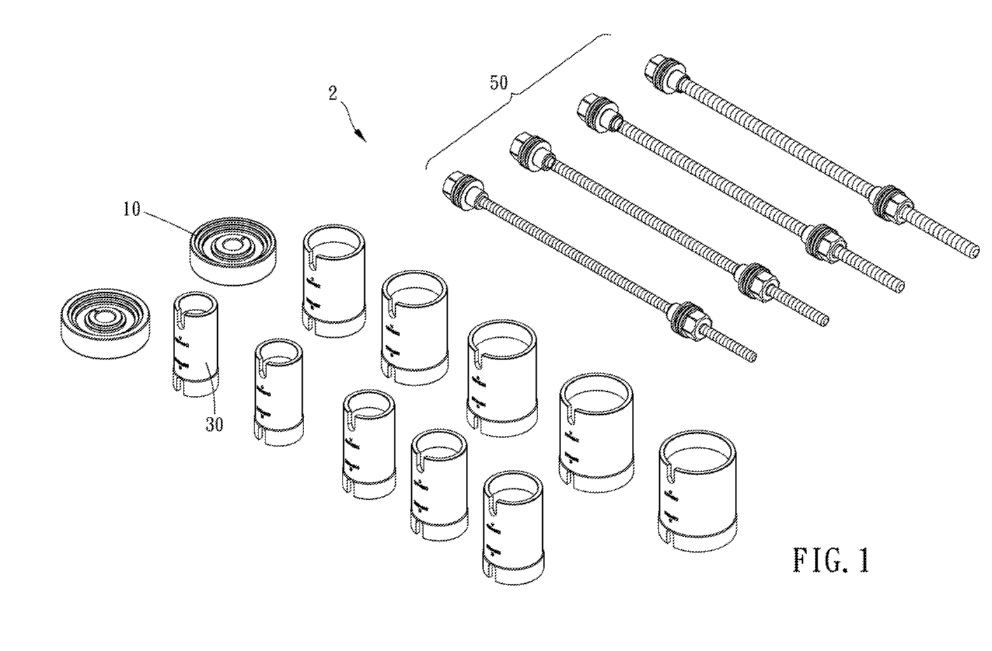

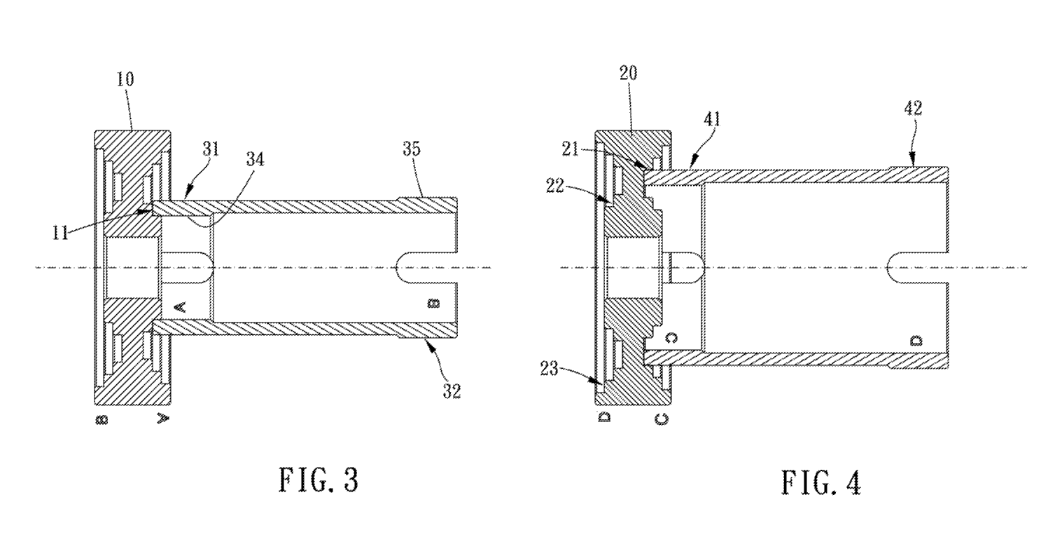

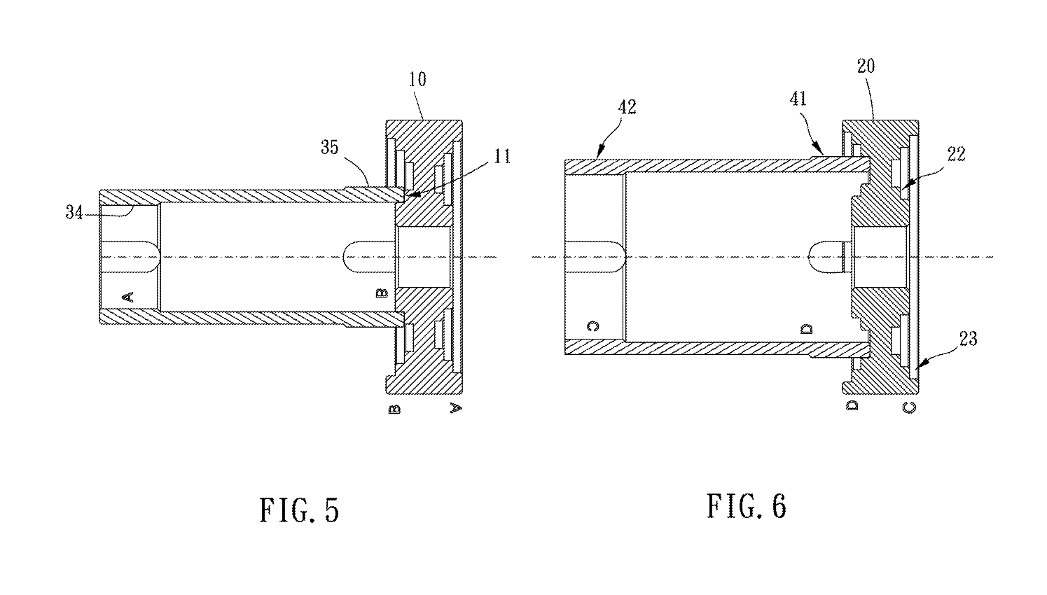

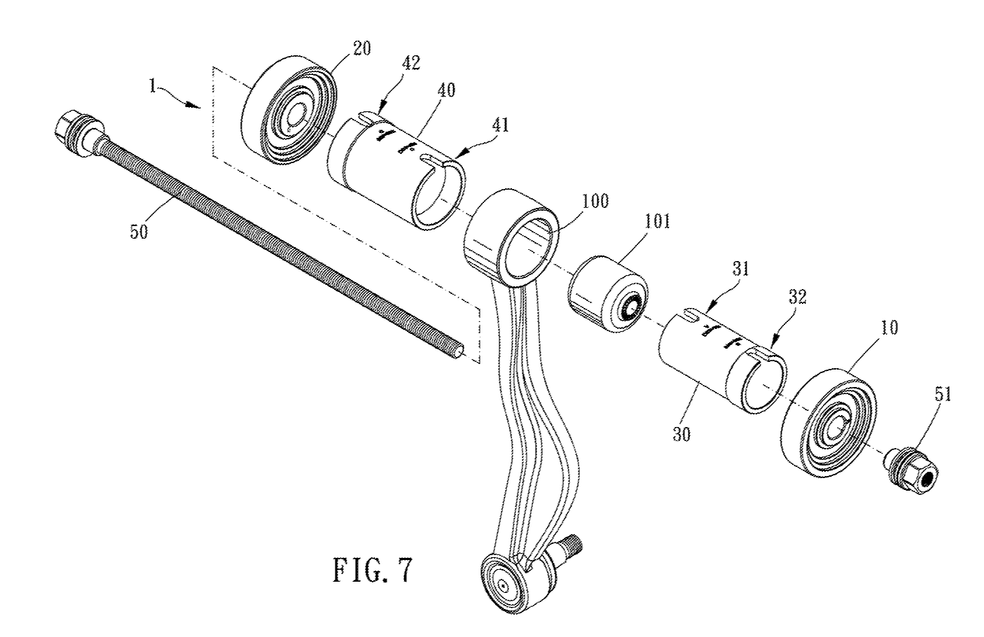

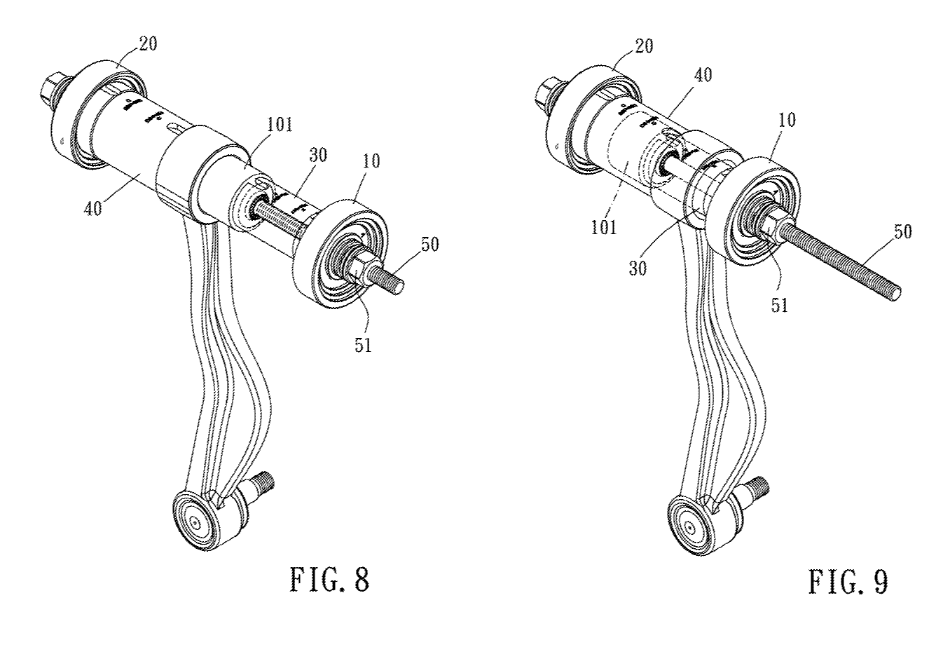

As shown in FIGS. 1, 2A, 2B and 3-9, a removal and installation tool 1 is provided for an insert 101 (such as a bearing) of an axial bore 100 of a device. The insert removal and installation tool includes a press member 10, an abutting member 20, a first tubular member 30, a second tubular member 40 and a bolt 50.

The press member includes a plurality of first engagement structures of at least two different dimensions. Specifically, two faces of the press member which are opposite axially include a plurality of said first engagement structures 11, respectively, the plurality of said first engagement structures on each of the two faces of the press member include a central portion 12 and a peripheral portion 13 separately disposed around the central portion, and the central portion and the peripheral portion each include at least two of said first engagement structures in a stepped configuration. The first tubular member has a first engagement end 31 and a second engagement end 32 which are opposite to each other. The first and second engagement ends of the first tubular member are selectively adaptively engageable with different two of the plurality of first engagement structures respectively, and one of the first and second engagement ends of the first tubular member is configured to engage with one said first engagement structure and the other is configured to abut against the insert. The second tubular member is abutted against the abutting member and configured to abut against the device. The bolt is configured to be disposed through the insert and the axial bore, the bolt is disposed through the press member, the first tubular member and the second tubular member. The bolt is connected with the press member and the abutting member. At least one of the press member and the abutting member is movably assembled to the bolt. However, a power cylinder or other actuation mechanism may be substituted for the bolt. Whereby, it can be compatible with various inserts of different sizes, and it has only a half of a number of parts of the conventional tool or tool set.

An interval between the central portion and the peripheral portion is greater than a thickness of a wall of each of the first tubular member and the second tubular member, thus allowing a thicker wall of the tubular member and having good structural strength. In this embodiment, the central portion is steppedly tapered down-top and outside-in, and the peripheral portion is steppedly raised down-top and inside-out. A number of the first engagement structures of the central portion is less than a number of the first engagement structures of the peripheral portion, and the central portion is lower than the peripheral portion; however, structures of the former and later may be exchanged). The plurality of first engagement structures are different in radial dimension, thus being compatible with various inserts of different sizes. Each of the first and second engagement ends of the first tubular member preferably includes a slot 33, and the slot is higher than the first engagement structures, thus being easy to observe removal or installation of the insert.

The first engagement end is selectively adaptively engageable with one said first engagement structure of one of the two faces, and the second engagement end is selectively adaptively engageable with one said first engagement structure of the other of the two faces. One of the first and second engagement ends of the first tubular member includes an inner radially-protruding flange 34, and the other of the first and second engagement ends of the first tubular member includes an outer radially-protruding flange 35. The inner radially-protruding flange and the outer radially-protruding flange are selectively adaptively engageable with respective two of the plurality of first engagement structures which are different in radial dimension. Specifically, the inner radially-protruding flange is selectively adaptively engageable with one said first engagement structure of the central portion, and the outer radially-protruding flange is selectively adaptively engageable with one said first engagement structure of the peripheral portion. The inner radially-protruding flange and the outer radially-protruding flange provide good structural strength and stable combination of the engaged parts.

Preferably, two faces of the press member which are opposite further include a first matching index 14 and a second matching index 15, and each of the first and second engagement ends of the first tubular member includes a third matching index 36 and a fourth matching index 37 matchable respectively with the first and second matching indexes, thus being easy and quick to pair the tubular member and the press member.

In this embodiment, two faces of the abutting member which are opposite axially include a plurality of second engagement structures 21, respectively, and the plurality of said second engagement structures on each of the two faces of the abutting member include a central portion 22 and a peripheral portion 23 separately disposed around the central portion. The central portion and the peripheral portion of the abutting member each include at least two of said second engagement structures in a stepped configuration. Similar to the first tubular member, the second tubular member has a first engagement end 41 and a second engagement end 42 arranged oppositely. The first and second engagement ends of the first tubular member are selectively adaptively engageable with two of the plurality of first engagement structures which are different in radial dimension or selectively adaptively engageable with two of the plurality of second engagement structures which are different in radial dimension. The first and second engagement ends of the second tubular member are selectively adaptively engageable with two of the plurality of first engagement structures which are different in radial dimension or selectively adaptively engageable with two of the plurality of second engagement structures which are different in radial dimension. According to various sizes of various inserts, function, and arrangement of the press member and the abutting member may be exchanged, thus providing double expandability and application. The first engagement structures or/and the second engagement structures may be annular or dashedly arranged, may be projection(s), boss(es), recess(es), or a combination thereof.

A removal and installation tool set 2 is further provided. The removal and installation tool set includes a plurality of aforementioned first tubular members and a plurality of aforementioned second tubular members. The removal and installation tool set may further include at least one of aforementioned bolt. The plurality of first engagement structures and the plurality of second engagement structures are different in radial dimension. Preferably, the removal and installation tool set includes a plurality of said bolts, wherein the plurality of bolts have different diameters or/and lengths, so that it can be chosen suitable one according to a specific size of an insert or/and axial bore.

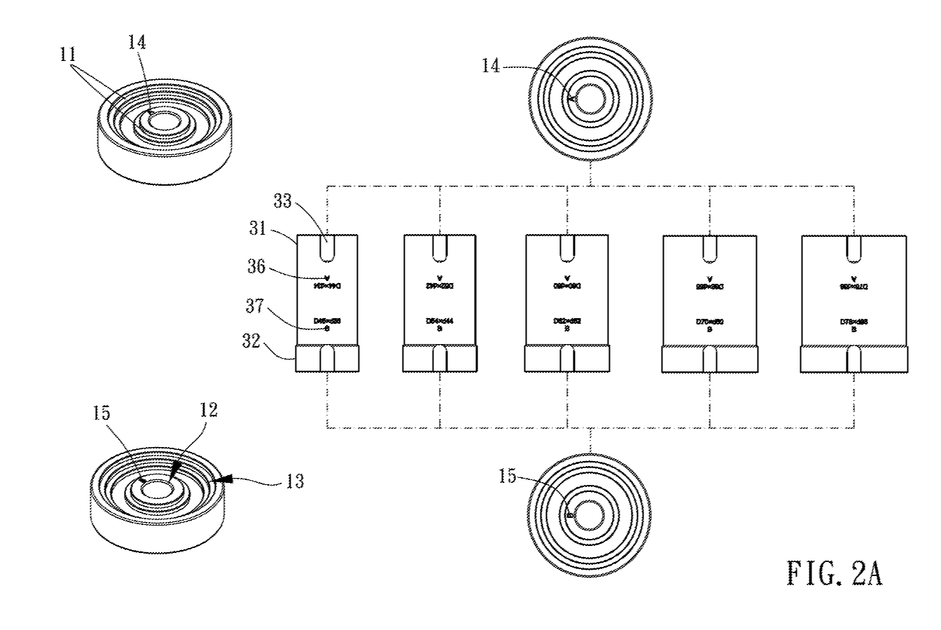

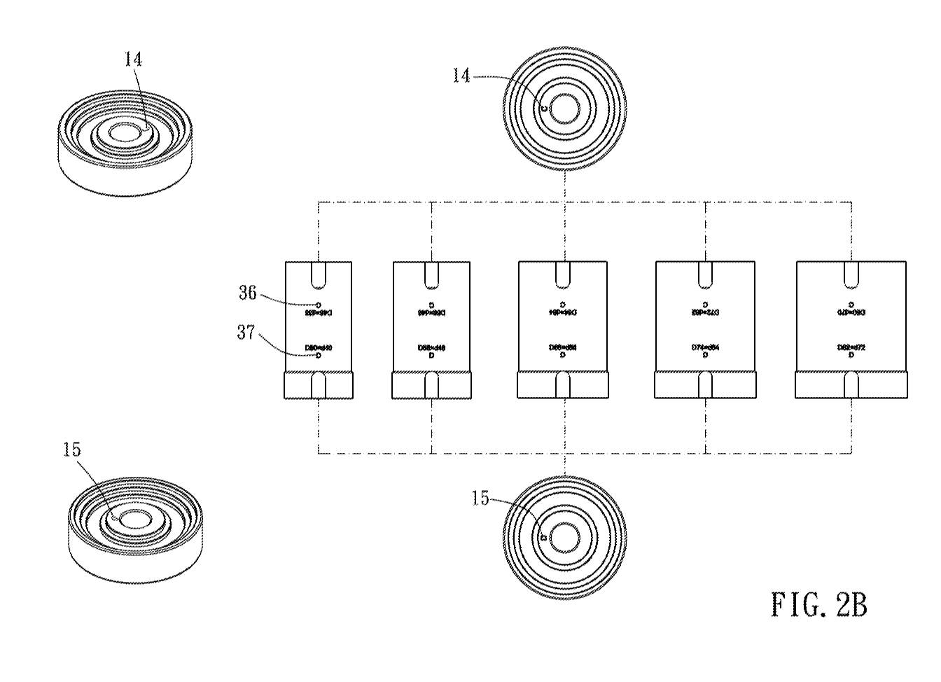

Preferably, the first matching index and the second matching index on the respective two faces of the press member are designated, for example, as A and B, the first matching index and the second matching index the abutting member on the respective two faces are designated, for example, as C and D, the third matching index and the fourth matching index on the first and second engagement ends of the first tubular member are also designated as A and B, and the third matching index and the fourth matching index of the second tubular member are also designated as C and D (as shown in FIGS. 2A and 2B). As a result, it is easy and quick to pair and use. In addition, each of the plurality of first tubular members and the plurality of second tubular members can be sleeved with one another, thus saving storage space.

In use, for example, a nut 51 screwed to the bolt is rotated to urge the press member to press the first tubular member so as to press the insert to move into or out of the axial bore. It is noted that the nut may be disposed on another end of the bolt to urge the abutting member; the press member or/and the abutting member may be provided with a through threaded hole so that the press member or/and the abutting member may be screwed directly to the bolt.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A removal and installation tool for an insert of an axial bore of a device is provided, including:
a press member, including a plurality of first engagement structures of at least two different dimensions; an abutting member;
a first tubular member, having a first engagement end and a second engagement end which are configured for selective engagement with different two of the plurality of first engagement structures respectively, disengageably abutted against one of the plurality of first engagement structures and being configured for abutment against the insert;
a second tubular member, disengageably abutted against the abutting member and being configured for abutment against the device.

2. The removal and installation tool of claim 1, wherein two faces of the press member which are opposite axially include a plurality of said first engagement structures, respectively, the plurality of said first engagement structures on each of the two faces of the press member include a central portion and a peripheral portion separately disposed around the central portion, and the central portion and the peripheral portion each include at least two of said first engagement structures in a stepped configuration.

3. The removal and installation tool of claim 2, wherein an interval between the central portion and the peripheral portion is greater than a thickness of a wall of each of the first tubular member and the second tubular member.

4. The removal and installation tool of claim 2, wherein the central portion is steppedly tapered down-top and outside-in, and the peripheral portion is steppedly raised down-top and inside-out.

5. The removal and installation tool of claim 1, further including a bolt, the bolt being configured to be disposed through the insert and the axial bore, the bolt being further disposed through the press member, the first tubular member and the second tubular member, the bolt being further connected with the press member and the abutting member, at least one of the press member and the abutting member being movably assembled to the bolt.

6. The removal and installation tool of claim 1, wherein two faces of the press member which are opposite further include a first matching index and a second matching index, respectively, and each of the first and second engagement ends of the first tubular member includes a third matching index and a fourth matching index matchable respectively with the first and second matching indexes.

7. The removal and installation tool of claim 2, wherein an interval between the central portion and the peripheral portion is greater than a thickness of a wall of each of the first tubular member and the second tubular member;
the central portion is steppedly tapered down-top and outside-in; the peripheral portion is steppedly raised down-top and inside-out; a number of the first engagement structures of the central portion is less than a number of the first engagement structures of the peripheral portion, the central portion is lower than the peripheral portion; the first engagement end is selectively adaptively engageable with one said first engagement structure of one of the two faces, the second engagement end is selectively adaptively engageable with one said first engagement structure of the other of the two faces; the two faces further include a first matching index and a second matching index, respectively, each of the first and second engagement ends of the first tubular member includes a third matching index and a fourth matching index matchable respectively with the first and second matching indexes; the plurality of first engagement structures are different in radial dimension; each of the first and second engagement ends of the first tubular member includes a slot, the slot is higher than the first engagement structures.

8. The removal and installation tool of claim 1, wherein one of the first and second engagement ends of the first tubular member includes an inner radially-protruding flange, and the other of the first and second engagement ends of the first tubular member includes an outer radially-protruding flange, and the inner radially-protruding flange and the outer radially-protruding flange are selectively adaptively engageable with two of the plurality of first engagement structures which are different in radial dimension.

9. The removal and installation tool of claim 8, wherein two faces of the abutting member which are opposite axially include a plurality of second engagement structures, respectively, the plurality of said second engagement structures on each of the two faces of the abutting member include a central portion and a peripheral portion separately disposed around the central portion, and the central portion and the peripheral portion of the abutting member each include at least two of said second engagement structures in a stepped configuration; the second tubular member has a first engagement end and a second engagement end arranged oppositely; the first and second engagement ends of the first tubular member are selectively adaptively engageable with two of the plurality of first engagement structures which are different in radial dimension or selectively adaptively engageable with two of the plurality of second engagement structures which are different in radial dimension; the first and second engagement ends of the second tubular member are selectively adaptively engageable with two of the plurality of first engagement structures which are different in radial dimension or selectively adaptively engageable with two of the plurality of second engagement structures which are different in radial dimension.

10. A removal and installation tool set, including a plurality of said first tubular members and a plurality of said second tubular members of claim 1
